(19) United States
(12) Patent Application Publication
(10) Pub. No.: US 2012/0132073 A1
(43) Pub. Date: May 31, 2012

(54) Method of Making an Activated Carbon Substrate Having Metal Sulfide

(76) Inventors: Benedict Yorke Johnson, Horseheads, NY (US); Samuel Odei Owusu, Horseheads, NY (US); Millicent Kaye Weldon Ruffin, Painted Post, NY (US)

(21) Appl. No.: 12/971,298

(22) Filed: Dec. 17, 2010

Related U.S. Application Data
(60) Provisional application No. 61/417,923, filed on Nov. 30, 2010.

(51) Int. Cl. B01D 53/02; B05D 3/02

(52) U.S. Cl. 95/134; 427/372.2

(57) ABSTRACT

A method of making a sorbent of an activated carbon substrate having a metal sulfide, which may be useful, for example, for removing a contaminant from a fluid stream.

This application claims the benefit of, and priority to U.S. Provisional Patent Application No. 61/417,923 filed on Nov. 30, 2010 entitled, “Method of Making an Activated Carbon Substrate Having Metal Sulfide”, the content of which is relied upon and incorporated herein by reference in its entirety.

### FIELD OF THE DISCLOSURE

The disclosure relates generally to a method of making a sorbent of an activated carbon substrate having a metal sulfide, which may be useful, for example, for removing a contaminant from a fluid stream.

### BACKGROUND

The emission of toxic metals has become an environmental issue of increasing concern because of the dangers posed to human health. For instance, coal-fired power plants and medical waste incineration are major sources of human activity related to toxic metal emission into the atmosphere. However, emission control regulations have not been rigorously implemented for coal-fired power plants. A major reason is a lack of effective control technologies available at a reasonable cost.

A technology currently in use for controlling mercury emissions from coal-fired power plants is activated carbon injection (ACI). The ACI process involves injecting activated carbon powder into a flue gas stream and using a fabric filter or electrostatic precipitator to collect the activated carbon powder that has sorbed mercury. ACI technologies generally require a high C:Hg ration to achieve the desired mercury removal level, which results in a high cost for sorbent material. The high C:Hg ration indicates that ACI does not utilize the mercury sorption capacity of carbon powder efficiently.

An activated carbon packed bed can reach high mercury removal levels with more effective utilization of sorbent material. On the other hand, a typical powder or pellet packed bed has a very high pressure drop, which significantly reduces energy efficiency. Further, these fixed beds are generally an interruptive technology because they require frequent replacement of the sorbent material.

### SUMMARY

Embodiments disclosed herein relate to a method of making a sorbent comprising the following steps (A) applying an aqueous metal salt solution to an activated carbon substrate, then (B) applying an aqueous sulfur compound solution to the substrate resulting from step (A), and then (C) heating the substrate resulting from step (B) to a temperature equal to or greater than 300° C.

Also disclosed herein is a method of contacting a fluid stream comprising a contaminant with a sorbent comprising a metal sulfide and removing at least a portion of the contaminant from the fluid stream.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### DETAILED DESCRIPTION

Embodiments disclosed herein relate to a method of making a sorbent comprising the following steps (A) applying an aqueous metal salt solution to an activated carbon substrate, then (B) applying an aqueous sulfur compound solution to the substrate resulting from step (A), and then (C) heating the substrate resulting from step (B) to a temperature equal to or greater than 300° C.

In some embodiments, the activated carbon substrate is in the form of a flow-through substrate. The term “flow-through substrate” as used herein means a shaped body comprising inner passageways, such as straight or serpentine channels and/or porous networks that would permit the flow of a gas stream through the structure. The flow-through substrate comprises a dimension in the flow-through direction of at least 1 cm, at least 2 cm, at least 3 cm, at least 4 cm, at least 5 cm, at least 6 cm at least 7 cm, at least 8 cm, at least 9 cm, or at least 10 cm from the inlet to the outlet. The flow-through substrates disclosed herein are expected in some embodiments, to be associated with low pressure drop as a fluid flows through the system.

In some embodiments, the activated carbon substrate is honeycomb shaped comprising an inlet end, an outlet end, and inner channels extending from the inlet end to the outlet end. In some embodiments, the honeycomb shaped activated carbon substrate comprises a multiplicity of cells extending from the inlet end to the outlet end, the cells being defined by intersecting cell walls. The honeycomb shaped activated carbon substrate could optionally comprise one or more selectively plugged cell ends to provide a wall flow-through structure that allows for more intimate contact between the fluid stream and cell walls. In some embodiments, the activated carbon substrate is monolithic.

Some embodiments of activated carbon substrate may have a relatively high surface area to weight ratio. For example, in some embodiments, activated carbon honeycomb substrates disclosed herein can have a surface area to weight ratio of at least 5 m²/g, at least 50 m²/g, at least 100 m²/g, at least 250 m²/g, at least 400 m²/g, at least 500 m²/g, at least 750 m²/g, or at least 1000 m²/g. In some embodiments, the surface area to weight ratio of activated carbon honeycomb substrate is in the range of from 50 m²/g to 2500 m²/g, from 200 m²/g to 1500 m²/g, or from 400 m²/g to 1200 m²/g.

The activated carbon substrates disclosed herein may have a pore microstructure. For example, in one embodiment, the activated carbon substrates may comprise a total open pore volume or porosity of at least about 10%, at least about 15%, at least about 25%, or at least about 35%. In some embodiments, the total porosity is in the range of from about 15% to about 70%, including porosities of about 20% to about 60%, about 20% to about 40%, and about 40% to about 60%.

In some embodiments, the channel density of a honeycomb shaped activated carbon substrate disclosed herein can range from 6 cells per square inch (cpsi) to 1200 cpsi, for example, 9 cpsi to 50 cpsi, 50 cpsi to 100 cpsi, 100 cpsi to 300 cpsi, 300 cpsi to 500 cpsi, 500 cpsi to 900 cpsi, or 900 cpsi to 1000 cpsi. In some embodiments, the wall thickness between the channels may range from 0.001 inches to 0.100 inches, or 0.02 inches to 0.08 inches.

Exemplary activated carbon substrates of some embodiments may be made by extrusion, compression, injection molding, or casting. An activated carbon substrate may be made, for example, by preparing a batch mixture, extruding the mixture through a die forming a honeycomb shape, drying, and optionally firing the substrate.

In some exemplary embodiments, an activated carbon substrate may be made by providing a batch composition comprising activated carbon particles and an organic or inorganic binder, shaping the batch composition, and optionally heat treating the activated carbon substrate. In other exemplary embodiments, an activated carbon substrate may be made by providing a batch composition comprising a carbon precursor, shaping the batch composition, optionally curing the composition, carbonizing the composition, and activating the carbonized composition.

Carbon precursors comprise synthetic carbon-containing polymeric material, organic resins, charcoal powder, coal tar pitch, petroleum pitch, wood flour, cellulose and derivatives thereof, natural organic materials such as wheat flour, wood flour, corn flour, nut-shell flour, starch, coke, coal, or mixtures or combinations of any two or more of these.

In some embodiments, the batch composition comprises an organic resin as a carbon precursor. Exemplary organic resins include thermosetting resins and thermoplastic resins (e.g., polyvinylidene chloride, polyvinyl chloride, polyvinyl alcohol, and the like). Synthetic polymeric material may be used, such as phenolic resins or a furfural alcohol based resin such as furan resins. Exemplary suitable phenolic resins are resole resins such as plyophen resins. An exemplary suitable furan liquid resin is Furcab-LP from QO Chemicals Inc., Ind., U.S.A. An exemplary solid resin is solid phenolic resin or novolak.

The batch compositions may optionally also comprise inert inorganic fillers, (carbonizable or non-carbonizable) organic fillers, and/or binders. Inorganic fillers can include oxide glass; oxide ceramics; or other refractory materials. Exemplary inorganic fillers that can be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates, e.g., wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, mullite, cordierite, silica, alumina, other oxide glass, other oxide ceramics, or other refractory material.

Additional fillers such as fugitive filler which may be burned off during carbonization to leave porosity behind or which may be leached out of the formed substrates to leave porosity behind, may be used. Examples of such fillers include polymeric beads, waxes, starch, natural or synthetic materials of various varieties known in the art.

Exemplary organic binders include cellulose compounds. Cellulose compounds include cellulose ethers, such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. An example methylcellulose binder is METHOCEL™ A, sold by the Dow Chemical Company. Example hydroxypropyl methylcellulose binders include METHOCEL™ E, F, J, K, also sold by the Dow Chemical Company. Binders in the METHOCEL™ 310 Series, also sold by the Dow Chemical Company, can also be used. METHOCEL™ A4M is an example binder for use with a RAM extruder. METHOCEL™ F240C is an example binder for use with a twin screw extruder.

The batch composition may also optionally comprise forming aids. Exemplary forming aids include soaps, fatty acids, such as oleic, linoleic acid, sodium stearate, etc., polyoxyethylene stearate, etc. and combinations thereof Other additives that can be useful for improving the extrusion and curing characteristics of the batch are phosphoric acid and oil. Exemplary oils include petroleum oils with molecular weights from about 250 to 1000, containing paraffinic and/or aromatic and/or alicyclic compounds, synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, soyabean oil etc. may also be useful.

After shaping a substrate from the batch composition, such as one comprising a curable organic resin, the substrate may optionally be cured under appropriate conditions. Curing can be performed, for example, in air at atmospheric pressures and typically by heating the composition at a temperature of from 70° C. to 200° C. for about 0.5 to about 5.0 hours. In some embodiments, the substrate is heated from a low temperature to a higher temperature in stages, for example, from 70° C., to 90° C., to 125° C., to 150° C., each temperature being held for a period of time. Additionally, curing may also be accomplished by adding a curing additive such as an acid additive at room temperature.

The cured substrate can then be subjected to a carbonization step. For instance, the cured substrate may be carbonized by subjecting the cured substrate to an elevated carbonizing temperature in an O₂-depleted atmosphere. The carbonization temperature can range from 600 to 1200° C., in some embodiments from 700 to 1000° C. The carbonizing atmosphere can be inert, comprising mainly a non reactive gas, such as N₂, Ne, Ar, mixtures thereof, and the like. At the carbonizing temperature in an O₂-depleted atmosphere, the organic substances contained in the cured substrate decompose to leave a carbonaceous residue.

The carbonized substrate may then be activated. The carbonized substrate may be activated, for example, in a gaseous atmosphere selected from CO₂, H₂O, a mixture of CO₂ and H₂O, a mixture of CO₂ and nitrogen, a mixture of H₂O and nitrogen, and a mixture of CO₂ and another inert gas, for example, at an elevated activating temperature in a CO₂ and/or H₂O-containing atmosphere. The atmosphere may be essentially pure CO₂ or H₂O (steam), a mixture of CO₂ and H₂O, or a combination of CO₂ and/or H₂O with an inert gas such as nitrogen and/or argon. Utilizing a combination of nitrogen and CO₂, for example, may result in cost savings. A CO₂ and nitrogen mixture may be used, for example, with CO₂ content as low as 2% or more. Typically a mixture of CO₂ and nitrogen with a CO₂ content of 5-50% may be used to reduce process costs. The activating temperature can range from 600° C. to 1000° C., in certain embodiments from 600° C. to 900° C. During this step, part of the carbonaceous structure of the carbonized substrate is mildly oxidized:

CO₂(g)+C(s)2CO(g),

H₂O(g)+C(s)H₂(g)+CO(g),

resulting in the etching of the structure of the carbonaceous substrate and formation of an activated carbon matrix that can define a plurality of pores on a nanoscale and microscale. The activating conditions (time, temperature, and atmosphere) can be adjusted to produce the final product with the desired specific area.

An aqueous metal salt solution disclosed herein is formed by mixing a water soluble metal salt with water. Applicable metal salts are capable of releasing metal ions in the aqueous solution, for example, transition metal salts of nitrates, chlorides, sulfates and acetates, and combinations thereof The aqueous metal salt solution may comprise metal ions of copper, zinc, manganese, iron, tin and combinations thereof.

The aqueous sulfur compound solution disclosed herein is formed by mixing a water soluble sulfur compound with water. Applicable sulfur compounds are capable of reacting with a metal ion to form a water insoluble metal sulfide. The sulfur compound may be selected from sodium sulfide, ammonium sulfide, thiourea and combinations thereof.

Embodiments disclosed herein include a step (A), applying an aqueous metal salt solution to an activated carbon substrate. Applying an aqueous metal salt solution to the activated carbon substrate acts to introduce metal ions into the pore network of the activated carbon substrate, thereby forming a metal ion impregnated activated carbon substrate. Applying the aqueous metal salt solution to the activated carbon substrate may occur via dip coating, spray drying or vacuum coating. As examples, the aqueous metal salt solution may be applied by dipping the activated carbon substrate in the aqueous metal salt solution, spraying the aqueous metal salt solution on the activated carbon substrate or utilizing a vacuum to “draw” the aqueous metal salt solution into and through an activated carbon substrate. In embodiments where the activated carbon substrate is dipped in the aqueous metal salt solution, the activated carbon substrate may be soaked in the aqueous metal salt solution at room temperature for a minimum of 10 minutes, 20 minutes, 30 minutes or 40 minutes.

Following application of the aqueous metal salt solution to the activated carbon substrate, the metal ion impregnated activated carbon substrate may be dried at a temperature of from 90° C. to 140° C. The metal ion impregnated activated carbon substrate may also be dried at a temperature above 140° C. In some embodiments, the metal ion impregnated activated carbon substrate is dried for a minimum of 30 minutes, 45 minutes, or 60 minutes.

Embodiments disclosed herein include a step (B), applying an aqueous sulfur solution to an activated carbon substrate. Applying an aqueous sulfur solution to the activated carbon substrate acts to introduce sulfur ions into the pore network of the activated carbon substrate, thereby reacting with the already impregnated metal ions to form water insoluble metal sulfide within the pore network of the activated carbon substrate. Applying the aqueous sulfur solution to the activated carbon substrate may occur via dip coating, spray drying or vacuum coating. As examples, the aqueous sulfur solution may be applied by dipping the activated carbon substrate in the aqueous sulfur solution, spraying the aqueous sulfur solution on the activated carbon substrate or utilizing a vacuum to “draw” the aqueous sulfur solution into and through an activated carbon substrate. In embodiments where the activated carbon substrate is dipped in the aqueous sulfur solution, the activated carbon substrate may be soaked in the aqueous sulfur solution at room temperature for a minimum of 10 minutes, 20 minutes, 30 minutes or 40 minutes.

Following application of the aqueous sulfur solution to the metal ion impregnated activated carbon substrate, the sulfur treated activated carbon substrate may be dried at a temperature of from 90° C. to 140° C. The sulfur treated activated carbon substrate may also be dried at a temperature above 140° C. In some embodiments, the sulfur treated activated carbon substrate is dried for a minimum of 30 minutes, 45 minutes, or 60 minutes.

Prior to step (C) the metal sulfide impregnated activated carbon honeycomb may be rinsed with distilled water to remove any water soluble reaction products. The water insoluble metal sulfides remain after rinsing.

Embodiments disclosed herein include a step (C), heating the substrate resulting from step (B) to a temperature equal to or greater than 300° C. Step (C) may also be referred to as a calcining step. Step (C) acts to crystallize the metal sulfide formed during step (B) of the method. In some embodiments, the substrate the substrate is heated to a minimum temperature of 300° C., 400° C., 500° C., or 600° C. in step (C). In some embodiments, the substrate is heated from 3 hours to 6 hours in step (C). In some embodiments, the substrate is heated greater than 6 hours in step (C). In some embodiments, step (C) occurs under a flow of nitrogen.

In some embodiments, step (A) and step (B) may occur at the same time. For example, an aqueous solution comprising both the metal salt and the sulfur compound may be applied to the activated carbon substrate. In these embodiments, a metal salt and sulfur compound are selected so that the metal sulfide formed is able to impregnate the pore network of the activated carbon substrate. For example, zinc salts and thiourea form a metal sulfide that is not too large to impregnate the pore network of the activated carbon structure.

The sorbent disclosed herein may be used, for example, for the sorption of a contaminant from a fluid stream through contact with the fluid. As disclosed herein the sorbent comprises an activated carbon substrate having metal sulfides impregnated in the pore network of the activated carbon substrate. For example, a fluid stream may be passed through inner passageways of a flow-through activated carbon substrate from the inlet end to the outlet end. The fluid stream may be in the form of a gas or a liquid. The gas or liquid may also contain another phase, such as a solid particulate in either a gas or liquid stream, or droplets of liquid in a gas stream. Exemplary gas streams include coal combustion flue gases (such as from bituminous and sub-bituminous coal types or lignite coal) and syngas streams produced in a coal gasification process.

As used herein, the terms “sorb,” “sorption,” and “sorbed,” refer to the adsorption, sorption, or other entrapment of the contaminant on the sorbent, either physically, chemically, or both physically and chemically.

Contaminants that may be sorbed include, for instance, contaminants at 3 wt % or less of the fluid stream, for example at 2 wt % or less, or 1 wt % or less. Contaminants may also include, for instance, contaminants at 10,000 μg/m³ or less within the fluid stream. Example contaminants include heavy metals. The term “heavy metal” and any reference to a particular metal by name herein includes the elemental forms as well as oxidized states of the metal. Sorption of a heavy metal thus includes sorption of the elemental form of the metal as well as sorption of any organic or inorganic compound or composition comprising the metal.

Example heavy metals that can be sorbed include cadmium, mercury, chromium, lead, barium, beryllium, and chemical compounds or compositions comprising those elements. For example, the metal mercury may be in an elemental (Hg^{o}) or oxidized state (Hg⁺ or Hg²⁺). Example forms of oxidized mercury include HgO and halogenated mercury, for example Hg₂Cl₂ and HgCl₂. Other exemplary metallic contaminants include nickel, cobalt, vanadium, zinc, copper, manganese, antimony, silver, and thallium, as well as organic or inorganic compounds or compositions comprising them. Additional contaminants include arsenic and selenium as elements and in any oxidation states, including organic or inorganic compounds or compositions comprising arsenic or selenium.

The contaminant may be in any phase that can be sorbed on the sorbent. Thus, the contaminant may be present, for example, as a liquid in a gas fluid steam, or as a liquid in a liquid fluid stream. The contaminant could alternatively be present as a gas phase contaminant in a gas or liquid fluid stream.

Various embodiments will be further clarified by the following examples.

### EXAMPLE 1

### Preparation of CuS-Based Activated Carbon Honeycomb (ACH)

2.5 g CuCl₂ (anhydrous) was mixed in 40 g DI-H₂O to provide an aqueous CuCl₂ solution. A 2.05 g ACH was soaked in the CuCl₂ solution for 10 minutes, removed and dried at 140° C. for 30 minutes. 15 g Na₂S.9H₂O was mixed in 60 g DI-H₂O to provide an aqueous Na₂S solution. The ACH treated above was soaked in the aqueous Na₂S solution for 15 minutes, removed and dried at 140° C. for 45 minutes. The treated ACH was calcined at 300° C. for 3 hours under a flow of nitrogen.

### EXAMPLE 2

### Preparation of MnS-Based ACH

2.5 g MnCl₂ (anhydrous) was mixed in 40 g DI-H₂O to provide an aqueous MnCl₂ solution. A 2.15 g ACH was soaked in the aqueous MnCl₂ solution for 10 minutes, removed and dried at 140° C. for 30 minutes. 15 g Na₂S.9H₂O was mixed in 60 g DI-H₂O to provide an aqueous Na₂S solution. The ACH treated above was soaked in the aqueous Na₂S solution for 15 minutes, removed and dried at 140° C. for 45 minutes. The treated ACH was calcined at 300° C. for 3 hours under a flow of nitrogen

### EXAMPLE 3

### Preparation of ZnS-Based ACH

2.25 g ZnCl₂ (anhydrous) and 4.0 g thiourea were mixed in 40 g DI-H₂O to provide an solution. A 2.22 g ACH was soaked in the aqueous solution for 60 minutes, removed and dried at 140° C. for 45 minutes. The treated ACH was calcined at 600° C. for 4 hours under a flow of nitrogen.

### EXAMPLE 4

### Preparation of SnS-Based ACH

2.5 g SnCl₂ (anhydrous) was mixed in 40 g DI-H₂O to provide an aqueous SnCl₂ solution. A 2.46 g ACH was soaked in the solution for 20 minutes, removed and dried at 140° C. for 45 minutes. 4.0 g thiourea (TU) was mixed in 40 g DI-H₂O to provide an aqueous TU solution. The ACH treated with SnCl₂ was soaked in the aqueous TU solution for 20 minutes, removed and dried at 140° C. for 45 minutes. The treated ACH was calcined at 750° C. for 6 hours under a flow of nitrogen.

Advantages of the embodiments disclosed herein include maximizing the presence of metal sulfides in the activated carbon matrix by pore volume impregnation of the metal sulfides. The highly dispersed metal sulfide in the pore network of the activated carbon substrate provides greater contact between mercury and metal sulfide resulting in improved mercury capture over current methods. The disclosed method allows high temperature sensitive metal sulfides to be processed at moderate temperatures. In addition, various metal sulfide precursor combinations can be utilized to form the desired metal sulfide.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of making a sorbent comprising the following steps:
(A) applying an aqueous metal salt solution to an activated carbon substrate; then
(B) applying an aqueous sulfur compound solution to the substrate resulting from step (A); and then
(C) heating the substrate resulting from step (B) at a temperature equal to or greater than 300° C.

2. The method of claim 1, wherein the activated carbon substrate is in the form of a flow-through substrate.

3. The method of claim 1, wherein the activated carbon substrate is honeycomb shaped.

4. A method of claim 1, wherein the aqueous metal salt solution comprises transition metal ions.

5. The method of claim 1, wherein the aqueous metal salt solution comprises ions of copper, zinc, manganese, iron, tin, and combinations thereof.

6. The method of claim 1, wherein the aqueous metal salt solution is formed from nitrates, chlorides, sulfates, acetates and combinations thereof.

7. The method of claim 1, wherein the aqueous sulfur compound solution is formed from sodium sulfide, ammonium sulfide, thiourea, or combinations thereof.

8. The method of claim 1, wherein the activated carbon substrate is exposed to the aqueous metal salt solution for a minimum of 10 minutes in step (A).

9. The method of claim 1, wherein step (A) further comprises drying the substrate at a temperature of from 90° C. to 140° C. after applying the aqueous metal salt solution.

10. The method of claim 1, wherein the substrate resulting from step (A) is exposed to the aqueous sulfur compound for a minimum of 10 minutes in step (B).

11. The method of claim 1, wherein step (B) further comprises drying the substrate at a temperature of from 90° C. to 140° C. after applying the aqueous sulfur solution.

12. The method of claim 1, wherein the substrate is heated at a temperature of from 300° C. to 600° C. in step (C).

13. The method of claim 1, wherein the substrate is heated to a temperature equal to or greater than 600° C. in step (C).

14. The method of claim 1, wherein the substrate is heated from 3 hours to 6 hours in step (C).

15. The method of claim 1, wherein the substrate is heated greater than 6 hours in step (C).

16. A method of making a sorbent comprising the following steps:
applying an aqueous solution comprising a metal salt and a sulfur compound to an activated carbon substrate; and
heating the substrate at a temperature equal to or greater than 300° C.

17. The method of claim 16, wherein the metal salt is a zinc salt and the sulfur compound is thiourea.

18. The method comprising:
contacting a fluid stream comprising a contaminant with the sorbent resulting from claim 1; and
removing at least a portion of the contaminant from the fluid stream.

19. The method of claim 18, wherein the contaminant is mercury.

20. The method of claim 18, wherein the fluid stream comprises SO₂, NO, NO₂, HCl, and combinations thereof.
